(19) United States
(12) Patent Application Publication
(10) Pub. No.: US 2017/0060820 A1
(43) Pub. Date: Mar. 2, 2017

(54) AUTHORING TOOL INCLUDING STYLE SELECTOR BARS FOR SELECTING STYLES FOR MEDIA COMPONENTS

(71) Applicant: Wrap Media, LLC, San Francisco, CA (US)

(72) Inventors: Jared L. FICKLIN, Austin, TX (US); Matthew J. SANTONE, Austin, TX (US)

(21) Appl. No.: 15/072,135

(22) Filed: Mar. 16, 2016

Related U.S. Application Data
(60) Provisional application No. 62/211,310, filed on Aug. 28, 2015.
(60) Provisional application No. 62/248,644, filed on Oct. 30, 2015.
(60) Provisional application No. 62/298,723, filed on Feb. 23, 2016.

(51) Int. Cl. G06F 17/21; G06F 3/0481; G06F 3/0484

(52) U.S. Cl. CPC G06F 17/212; G06F 3/04842; G06F 3/04847; G06F 17/214; G06F 3/04817

(57) ABSTRACT

An authoring tool for stylizing components, including a component tool for defining a component that can be stylized, a style selector bar tool defining a plurality of segments and a look up table that associates the plurality of segments with a plurality of stylized choices respectively. When a segment is selected, the authoring tool reads from the lookup table and applies the stylizing choice corresponding to the selected segment to the component. In various embodiments, the component is a text, image/photo, video, audio, button, etc.

### CROSS REFERENCE TO RELATED APPLICATIONS

This application claims the benefit of U.S. Provisional Application Nos. 62/211,310 (WRAPP0025P) filed Aug. 28, 2015, 62/248,644 (WRAPP025P2) filed Oct. 30, 2015, both entitled “System and Method for Authoring of Wrap Packages on Mobile Devices”. This application further claims the benefit of U.S. Provisional Application No. 62/298,723 (WRAPP025P3) filed Feb. 23, 2016 and entitled “Mobile-First Authoring Tool for the Authoring of Wrap Packages”. Each of the above-listed priority applications is incorporated herein by reference for all purposes.

### BACKGROUND

This invention relates to the stylizing of media components, and more particularly,to the use of style selector bars to selectively modify style(s) of media components.

Electronic media authoring tools, such as word processing programs, tools for creating and editing PDF files, web page creation tools, application development tools and the like, typically include a variety of features and functions for specifying the style of various media components.

For text components, such tools will typically include pull-down menus, data entry windows and/or style buttons for modifying the style of text. By using these tools, an author can stylize various constraints of text, such as color, font type, font size, font style (bold, italic, strike-through, sub-script, super-script), alignment, justification, etc.

For image components, such tools rely on a similar approach. Pull down menus, data entry boxes and pie charts, buttons, graphs, etc. are typically provided to enable an author to alter the style of an image or photo component, such as filtering, mask radius, mask type, and/or image styles, such as frame, back drop shadow.

For drawing/scribble components, such tools include pull down menus, style buttons and/or data entry windows for stylizing constraints such as brush size, brush type, color, etc.

For button components, style constraints like button shape, border radius, color, button label font and/or color, are again typically chosen using pull down menus, style buttons, and/or data entry boxes.

For audio and video components, a similar approach of using pull down menus and/or data entry windows are used for adjusting constraints such as DSP filtering, the graphic representation of play icons, mask radius, etc.

The above-mentioned pull down menus, data entry windows, style buttons, pie charts and the like are adequate for defining style choices for various media types in a desktop authoring environment. On a mobile device, however, the implementation of many of these style tools is less than adequate. On a mobile device, such as a cellular phone, it is cumbersome to use or manipulate pull down menus or enter data into windows due to a combination of factors, such as small screen sizes and/or virtual keyboards. As a result, using the above-described style tools is less than ideal in a mobile authoring environment.

The use of volume control bars, scrubber bars and the like is well known in the computing field. With audio and video files, sliding a finger or other pointing device along the volume bar will result in an adjustment of the playback volume of the audio. In other words, manipulation of the volume bar adjusts the amplitude of volume control signals that are applied to the audio circuitry of the rendering device, resulting in the audio playing louder or softer. Similarly, by sliding a scrubber bar, the time position in the rendering of the media of the file can be defined by the viewer. For example, if a video file is 3.00 minutes long, a viewer can slide the scrubber bar and begin rendering at any intermediate time point between the start and end of the file. If the scrubber bar is positioned at the 1:35 time index for instance, then the rendering of media of the file will begin at this time mark. In both these examples, the media contained in the file is not altered, adjusted or stylized in any manner. On the contrary, the media of the file, and any constraint associated therewith, remains the same and is not stylized in any manner.

Also, slider bars that rely on an algorithm are also known. For example, an authoring tool may include a black/white filter button. When selected, a slider bar appears, allowing an author to chose or define the strength of the filter. In other words, an algorithm that determines the percentage of filtering (i.e., 0.00 to 100%) that an author would like to be applied to the components based on control of the slider bar input.

With the growing popularity of mobile devices, such as smart phones and tablets, both web based and applications (i.e., “apps”) for mobile authoring are becoming popular. In a mobile authoring environment, users can create and edit media. However, stylizing this media on a mobile device using the aforementioned approaches typically used in a desktop authoring environment is often very difficult. An easier technique for styling the constraints of media, more conducive to mobile devices, is therefore needed.

### SUMMARY

The present application is directed to an authoring tool for stylizing components of a document. The authoring tool including a component tool for defining a component that can be stylized, a style selector bar tool defining a plurality of segments and a look up table that associates the plurality of segments with a plurality of stylized choices respectively. When a segment is selected, the authoring tool reads from the lookup table and applies the stylizing choice corresponding to the selected segment to the component. When the pointing device is moved along the style selector bar tool from one segment to the next, the authoring tool updates “on the fly” the the style applied to the component based on the segment position of the pointing device. As a result, the author can view and select the various style choices applied to component by swiping along the style selector bar.

In various alternative embodiments, a number of different style selector bars may be provided for multiple types of components. For example, style selector bars may be provided for text, image/photo, scribble/drawing, audio, video and button type components respectively.

In yet other embodiments, multiple style selector bars may also be provided for different style constraints of a given component.

In one embodiment, the style selector bar tool is shaped as a straight line. It should be understood, however, that straight is by no means a requirement. In alternative embodiments, style selector bars can be configured in any shape, including, but not limited to round, curved, semi-circular, etc.

In yet other embodiments, style selector bars can be used in mobile or desktop authoring environments. In addition, the pointing device can be either a finger or stylus in the case of touch-sensitive display screens or a mouse controlled curser with non-touch sensitive screens.

### BRIEF DESCRIPTION OF THE DRAWINGS

The invention and the advantages thereof, may best be understood by reference to the following description taken in conjunction with the accompanying drawings in which:

FIG. 1 is a diagram illustrating a non-exclusive embodiment of a style selector bar in accordance with the present invention.

FIG. 2A and 2B are diagrams illustrating non-exclusive embodiments of computing hardware for implementing style selector bar(s) in accordance with a non-exclusive embodiment of the present invention.

FIG. 3A through 3H are examples of style tables used for implementing style selector bars in accordance with a number of non-exclusive embodiments of the present invention.

FIG. 4 is a flow diagram illustrating non-exclusive steps for implementing style selector bars in accordance with the present invention.

FIG. 5 is a diagram illustrating non-exclusive embodiment for implementing style selector bars for text components in accordance with the present invention.

FIG. 6 is a diagram illustrating non-exclusive embodiment for implementing style selector bars for image components in accordance with the present invention.

FIG. 7 is a diagram illustrating non-exclusive embodiment for implementing style selector bars for drawing/scribble components in accordance with the present invention.

FIG. 8 is a diagram illustrating non-exclusive embodiments of using style selector bars for defining styles associated with sound components in accordance with the present invention.

FIG. 9 is a diagram illustrating non-exclusive embodiments of using style selector bars for defining styles associated with button components in accordance with the present invention.

In the drawings, like reference numerals are sometimes used to designate like structural elements. It should also be appreciated that the depictions in the figures are diagrammatic and not to scale.

### DETAILED DESCRIPTION OF THE PREFERRED EMBODIMENTS

The invention will now be described in detail with reference to various embodiments thereof as illustrated in the accompanying drawings. In the following description, specific details are set forth in order to provide a thorough understanding of the invention. It will be apparent, however, to one skilled in the art, that the invention may be practiced without using some of the implementation details set forth herein. It should also be understood that well known operations have not been described in detail in order to not unnecessarily obscure the invention.

Within a typical authoring environment, there are a number of different component types, including but not limited to, text components, photo/image components, video components, drawing/paint components (sometimes referred to herein as “scribble”), audio components, and button components.

A component is defined by its “type”, a specific content format, and certain applicable constraints. The content format(s) and constraint(s)/style(s) for various component types are summarized in the tables below:

A text component, typically having content format of ASCII characters, may have styles/constraints such as:

Constraint(s)/Style(s)

Font type
Styles (bold, italic, underline, strike-through, highlight,
superscript, subscript, etc.
Alignment
Color
Justification

A photo/image component, which may have content formats including GIFs, JPEG, JPG may have styles/constraints such as:

Constraint(s)/Style(s)

Filter
Mask Radius
Mask Type (share, circle, complex, etc.)
Filter (black and white, colorized, sepia, etc.)
Image style (frame, drop shadow, Polaroid, etc.)

A drawing/scribble component, which typically will have a vector content format, may have constraints/styles such as:

Constraint(s)/Style(s)

Brush size
Brush type (solid, dashed, artistic, etc.)
Color

A button component, which may have various content formats such as ASCII, CSS, Image, etc., may have constraints/styles such as:

Constraint(s)/Style(s)

Button Shape
Border Radius
Color
Graphic representation of button
Button label font
Button label color

An audio component, which may have various content formats such as MP3, FLAC, WAV., etc., may have constraints/styles such as:

Constraint(s)/Style(s)

Graphic Representation of Play Icon
DSP Filter

Finally, a video component, which may have content formats such as MPEG, MOV, etc., may have constraints/styles such as:

Constraint(s)/Style(s)

Mask Radius
Filter
Graphic Representation of Play Icon

### Style Selector Bars

The present application is directed to an authoring tool including (i) a component tool for defining a component that can be stylized and (ii) a style selector bar tool for previewing and assigning one of a plurality of stylized choices for the component. As a pointing device is moved along the style selector bar, the authoring tool updates the preview of the stylized choices for the constraint. When the pointing device is removed from the style selector bar, the last previewed style is assigned to the constraint. In various embodiments, the component is a text, image/photo, video, audio, button, etc.

The exemplary style selector bars provided below are described in the. context of a mobile-first authoring tool, such as that described in co-pending, commonly assigned, U.S. Application Ser. No. 62/298,723 (WRAP P025P3) filed Feb. 23, 2016 and entitled “Mobile-First Authoring Tool for the Authoring of Wrap Packages”, and incorporated herein for all purposes. With this authoring tool, component tools are provided to create various component types, such as text, sound, image/photo, video and/or buttons. Once such components are created, the style selector bars as described herein may be used to preview and assign different styles to each, as provided in the illustrative examples below.

It should be understood, however, that the above-identified mobile-first authoring tool is just one possible environment in which style selector bars may be used. In other embodiments, style selector bars can be used in cooperation with any authoring tool having or otherwise defining components with style constraints.

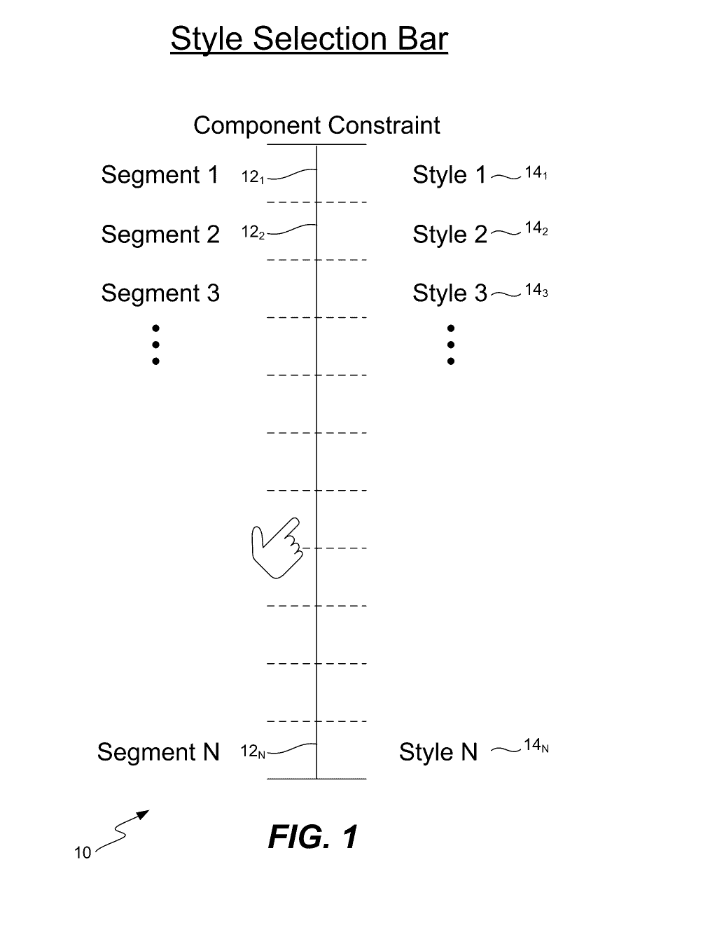

With respect to FIG. 1, a generic style selector bar is described. With respect to subsequent figures, examples of specific style selector bars for text, image/photo, drawing sound/audio, and button components are provided.

Referring to FIG. 1, a style selector bar 10 is illustrated. In this particular non-exclusive embodiment, the style selector bar 10 is shaped in a straight line and is segmented into a number of segments 12₁ through 12ₙ. A plurality of styles 14₁ through 14ₙ is associated with each of the segments 12₁ through 12ₙ respectively.

During operation, an author moves a pointing device, such as a finger or stylus, up and down the style selector bar 10. As the pointing device transitions from segment to segment 12, the associated style 14 is applied to the component. As a result, the author can see or otherwise experience the different styles applied to the component as they move the pointing device up and down the style selector bar 10. When the pointing device is released and is no longer contacting the style selector bar 10, the style 14 corresponding to the segment 12 last contacted is assigned to the component.

After a use of the style selector bar 10, the author can go back and use it again to change the style of the constraint. Thus, for a given component, an author can use the style selector bar 10 any number of times to change or adjust the style as desired.

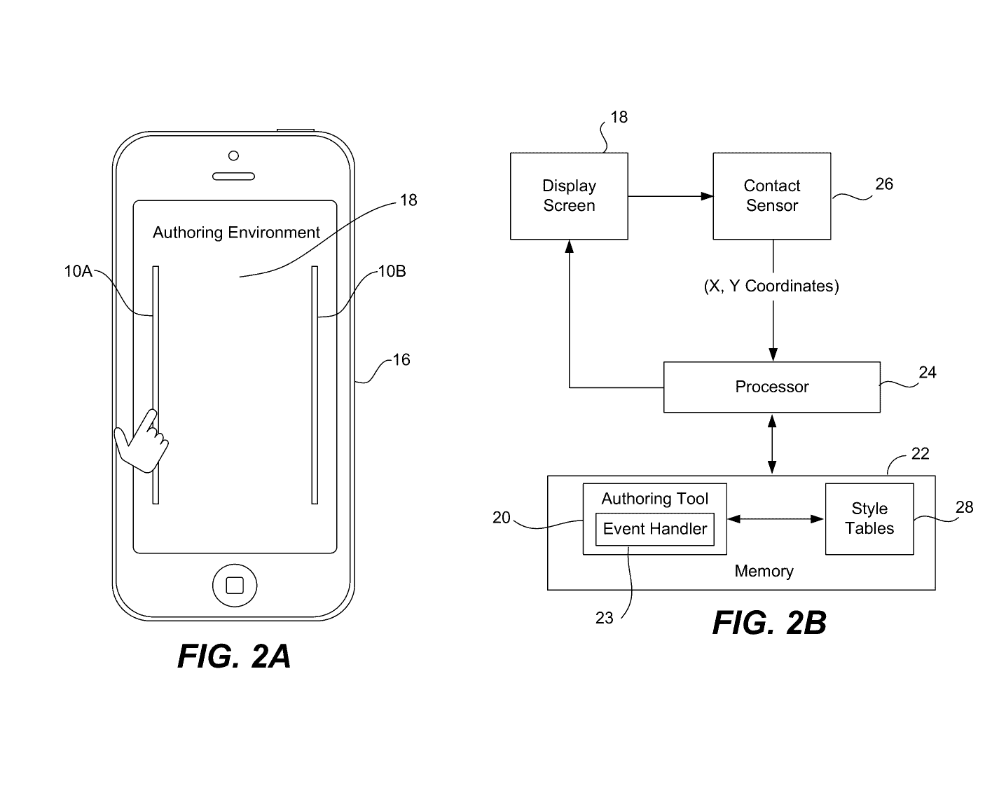

Referring to FIG. 2A and 2B, diagrams illustrating non-exclusive embodiments of computing hardware for implementing style selector bar(s) in a mobile authoring environment are illustrated.

In FIG. 2A, a mobile device 16 with a touch-sensitive screen 18 is illustrated. In this example, two style selection bars 10A and 10B appear on the screen 18 within a mobile authoring environment. Again, when either bar 10A or 1.0B is used, various styles for the corresponding component (not illustrated) is rendered on the device 16 “on the fly”, as the author slides a finger or other pointing device up/down either bar respectively.

Depending on the nature of the style selection bars 10A and/or 10B, the rendering of the various styles associated with each may vary. For example, with visual styles such as color, fonts, etc., the style choices will be rendered on the display 18 as they are selected. Alternatively, with audio related components, different styles, such as different DSP filter choices, would be rendered through speaker(s) on the device 16.

FIG. 2B illustrates a block diagram of the hardware and software components for implementing the style selection bars 10 on mobile device 16. The hardware components include, besides the screen 18, a processor 24 and a contact sensor 26, which generates (X,Y) coordinate samples in response to contact events that occur on the display 18. The authoring tool 20 is a software application that is maintained in memory 22. The authoring tool 20 includes an event handler 23, which interpret events that occur on the display 18 of the device 16 in response to the (X,Y) coordinate information received from sensor 26.

The authoring tool 20 is executed by processor 24. During the course of operation, one or more style selection bars 10 may be presented on the display 18 during an authoring session. As input events occur on the display 18 of the mobile device 16, such as a contacting or swiping action by a pointing device, the contact sensor 26 generates (X,Y) coordinate information at periodic sample intervals sufficient to ascertain the (X,Y) location of any contact event on the display 18 and a tracing of any contact movement across the display 18, such as a swiping action.

In response, the event handler 23 interprets the (X,Y) sample information and ascertains:

(a) if a contact is adjacent to and invoking one of the style selection bars 10;

(b) if a swiping action is occurring along the bar 10; and

(c) which segment 12, among all the segments 12₁ through 12_{N} along the bar 10, the author is currently selecting during the contact and/or swipe.

One or more style tables 28 are maintained in the memory 22 and are accessible by the authoring tool 20. Each table 28 includes a style choice for each segment 12 of a corresponding bar 10 in the authoring environment respectively.

When the event handler 23 ascertains the selection of a segment 12 of a bar 10, the authoring tool 20 accesses the corresponding style table 28 and looks up and reads the appropriate style 14 for the segment 12. The authoring tool 26 then applies the accessed style 14 to the component.

If the pointing device is moved along the selection bar 10, for example in a swiping action, the appropriate styles 14 are read from the table 28 and applied to the component, as the contact transitions from segment 12 to segment 12. In this manner, the various styles 14 associated with a given style selection bar 10 can be updated and rendered “on the fly” in response to the author swiping along the style selection bar 10.

When the pointing device is removed from the display 18, the last selected style is applied to the component until the style bar 10 is used again and the style is optionally changed.

In various embodiments, the display 18 is a capacitive touch screen, a resistive touch screen, or a combination resistive-capacitive touch screen. The screen sensor circuity 26, depending on the screen type, is arranged to detect the (X,Y) coordinates of any contact on the screen 18 by a pointing device using resistance, capacitance, or a combination of both. As touch screens 18 and sensor circuitry 26 are both well known in the art, a detailed explanation of each is not provided herein.

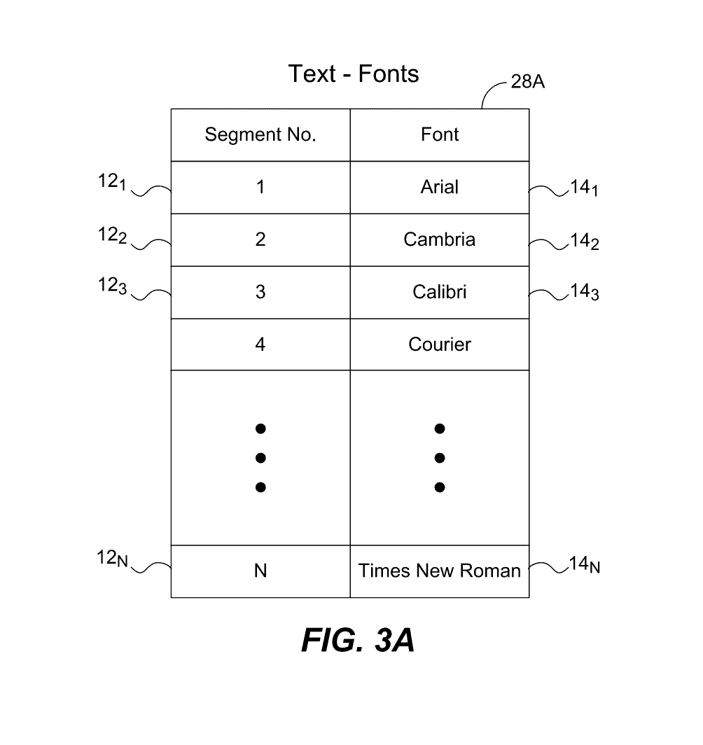

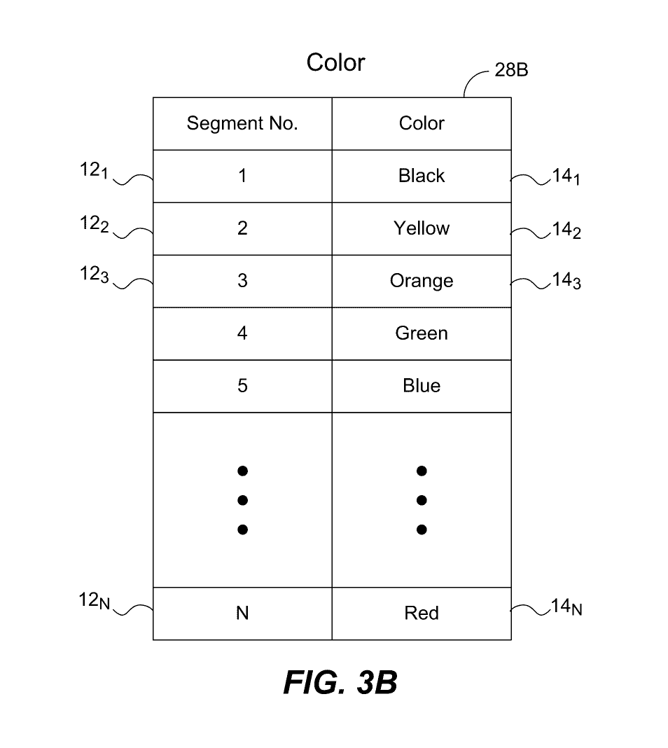

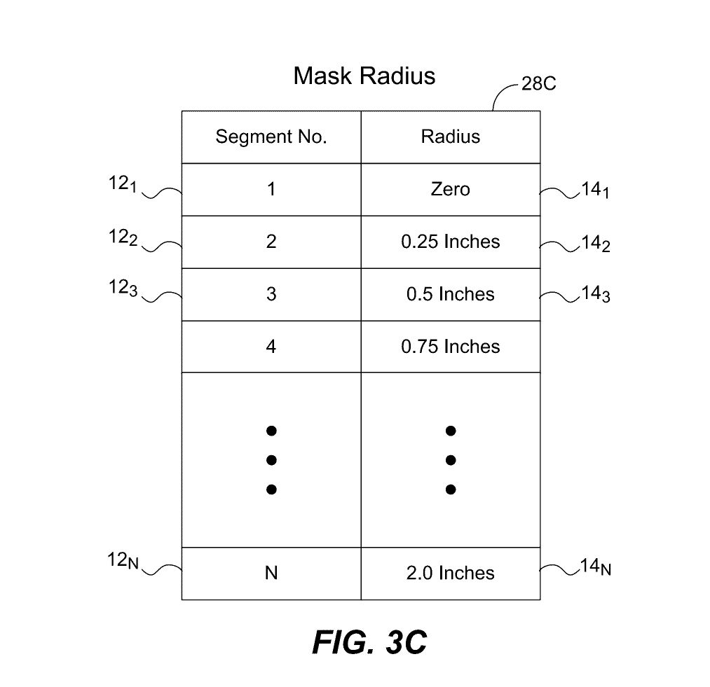

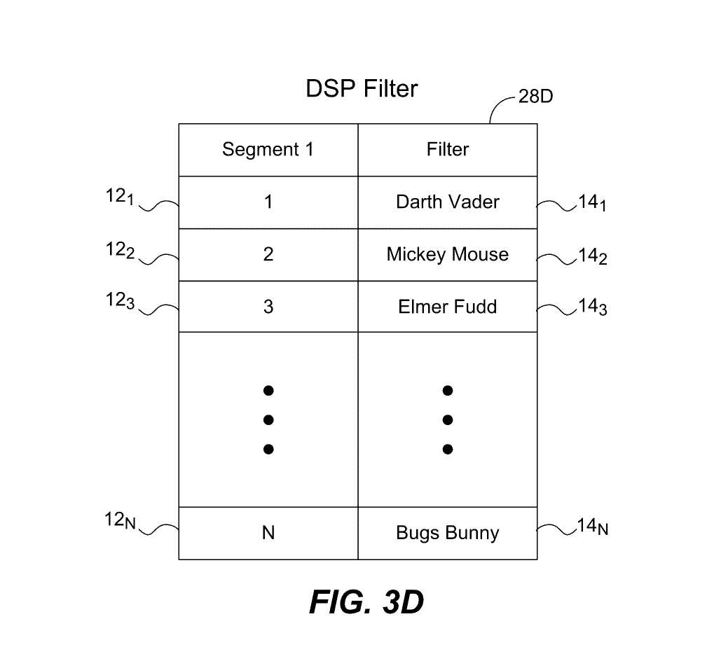

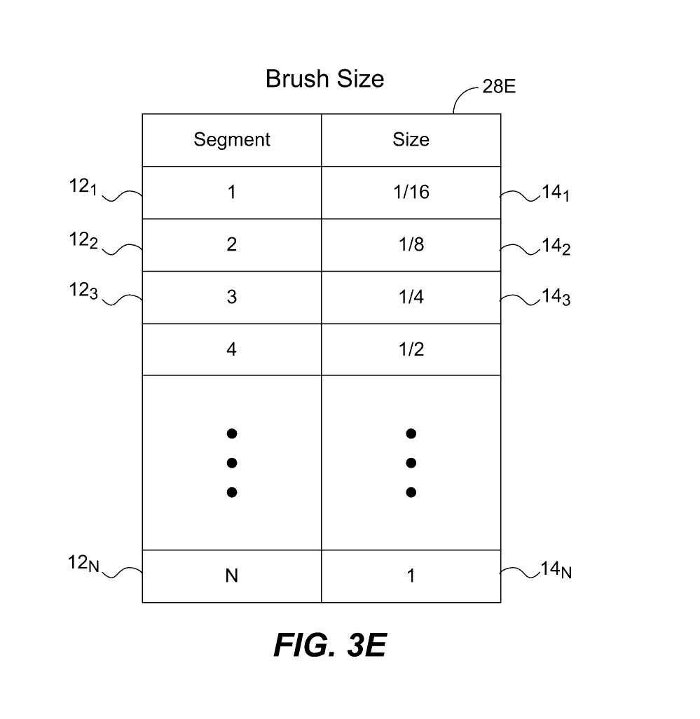

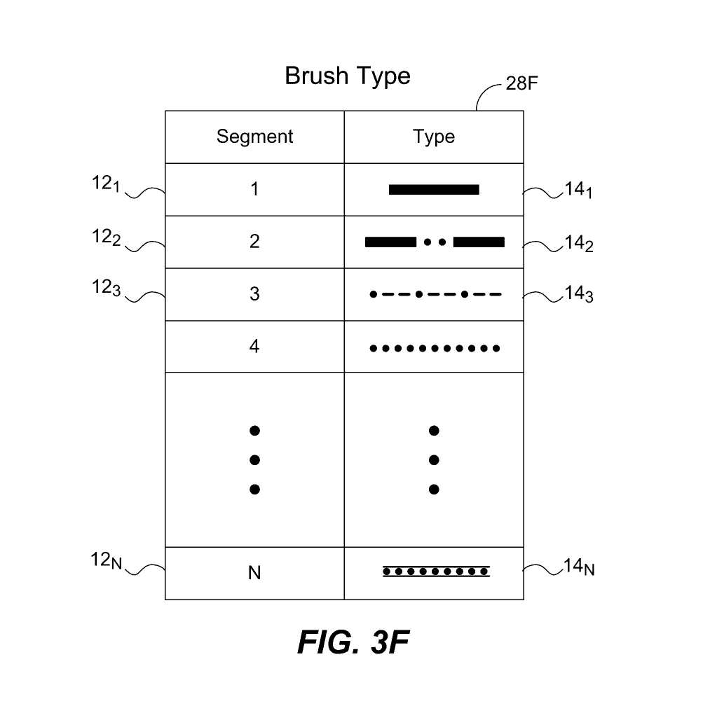

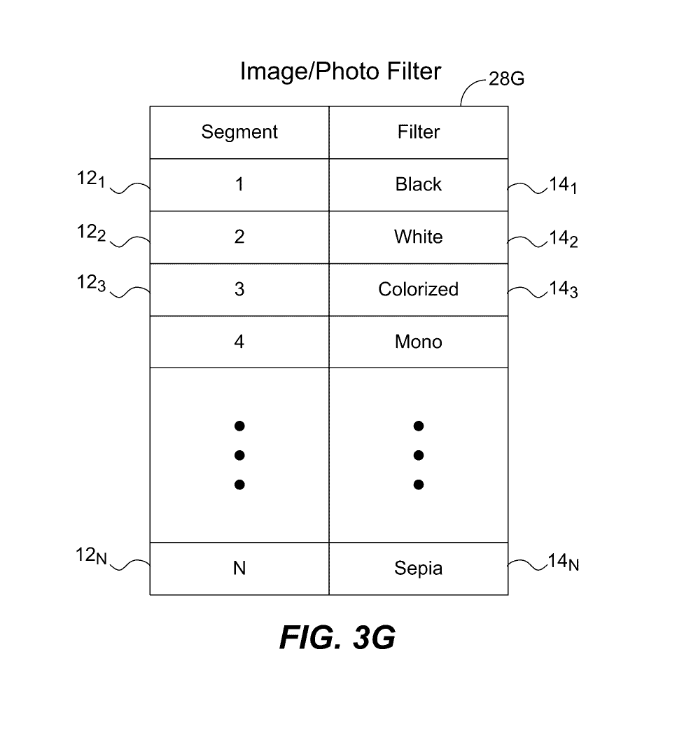

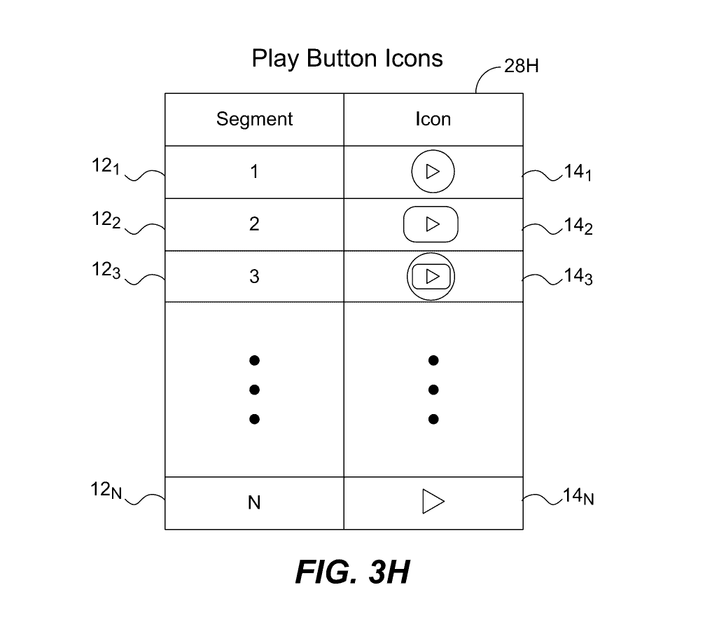

FIG. 3A through FIG. 3H are several examples of style tables 28 used in implementing different style selector bars 10.

FIG. 3A shows an exemplary style table 28A for defining font styles corresponding to a font style bar 10 for text components. As the various segments 12₁ through 12_{N} of the bar 10 are ascertained, the corresponding font (e.g., Arial, Cambria, Calibri, etc.) is read from the table 28A and applied to the text component.

FIG. 3B shows an exemplary style table 28B for defining color styles corresponding to a color style bar 10 for various components that can be colorized, such as text, a play button, brush color, etc. Again, as the various segments 12₁ through 12_{N} of the bar 10 are ascertained, the corresponding color (e.g., black, yellow, orange, green, etc.) is read from the table 28B and applied to the component.

FIG. 3C shows an exemplary style table 28C for defining a mask radius for a mask radius style bar. Again, as the various segments 12₁ through 12_{N} of the bar are ascertained, the corresponding mask radius (e.g., zero, 0.25 inches, 0.5 inches, 0.75 inches, etc.) is read from the table 28C and applied to the component, such as an image or photo.

FIG. 3D shows an exemplary style table 28D for defining a DSP filter for a voice filtering style selector bar 10. Again, as the selection by a pointing device of the various segments 12₁ through 12_{N} of the bar are ascertained, the corresponding filter (e.g., making voice sound like Darth Vader, Mickey Mouse, Elmer Fudd, Bugs Bunny, etc.) is read from the table 28D and applied to the voice component.

FIG. 3E shows an exemplary style table 28E for defining a brush stroke thicknesses for a brush stroke style bar. Again, as the various segments 12ₜ through 12_{N} of the bar are ascertained, the corresponding brush thickness (e.g., 1/16, ⅛, ¼, ½, 1, etc.) is read from the table 28E and applied to the brush stroke component.

FIG. 3F shows an exemplary style table 28F for defining a brush stroke type for another brush stroke style bar. Again, as the various segments 12₁ through 12_{N} of the bar are ascertained, the corresponding brush stroke type (e.g., solid line, dots, etc.) is read from the table 28F and applied to the brush stroke component.

FIG. 3G shows an exemplary style table 28G for defining a different image/photos filters for an an image/photo filter style bar. Again, as the various segments 12₁through 12_{N} of the bar are ascertained, the corresponding filter type black, white, colorized, sepia, etc.) is read from the table 28G and applied to the image/photo component.

FIG. 3H shows an exemplary style table 28H for defining a different play button styles. Again, as the various segments 12₁ through 12_{N} of the bar are ascertained, the corresponding play button style read from the table 28H and applied to a play button.

It should be noted that the tables 28A through 28H are merely exemplary of possible style tables 28 that typically would be used. In actual embodiments, at least one style table 28 would be provided for each style selection bar provided for selecting the style associated with any text, photo/image, drawing/scribble, button, audio and/or video component.

In the aforementioned embodiments, a look-up table approach is used for defining the style that corresponds to a segment of a given style bar 10. It should be understood, however, that this approach is merely exemplary and that other approaches may be used. For example, various algorithms may be use to define different style choices as a pointing device is moved from segment 12 to segment 12 of a bar 10. For instance, the spectrum of colors is typically represented in a computer by using eight bit words for each of the primary colors (Red, Blue Green). Each primary color is thus represented by 2⁸ or 256 levels. An algorithm can thus be used that defines different levels of Red. Blue and Green for each segment 12 of a bar. A similar algorithmic approach can be used for other styles that similarly can be represented as a spectrum, such as the filtering levels applied to an image or photo.

It should also be noted that the number of segments 12 per bar 10 may widely vary from two to a large number. In situations when many segments are desired, the number that can be practically used is limited by a number of factors, such as the size of the display screen of the authoring device, the length of the style bar, and the pitch between each of the segments. If the pitch becomes too small, it may be difficult for an author to differentiate a desired segment without possibly accidently selecting an adjacent segment with their pointing device. With this in mind, it is helpful for the pitch between segments to be sufficiently large to accommodate the size of the pointing device, which will often be a finger, which would typically (although not necessarily) be used in a mobile authoring environment on a mobile phone for example. In a desktop authoring environment, the number of segments that may be used could possibly, although not necessarily, be larger for a number of reasons, including larger screen sizes and longer style bars 10, and smaller-pitched pointing devices, such as a mouse controlled curser.

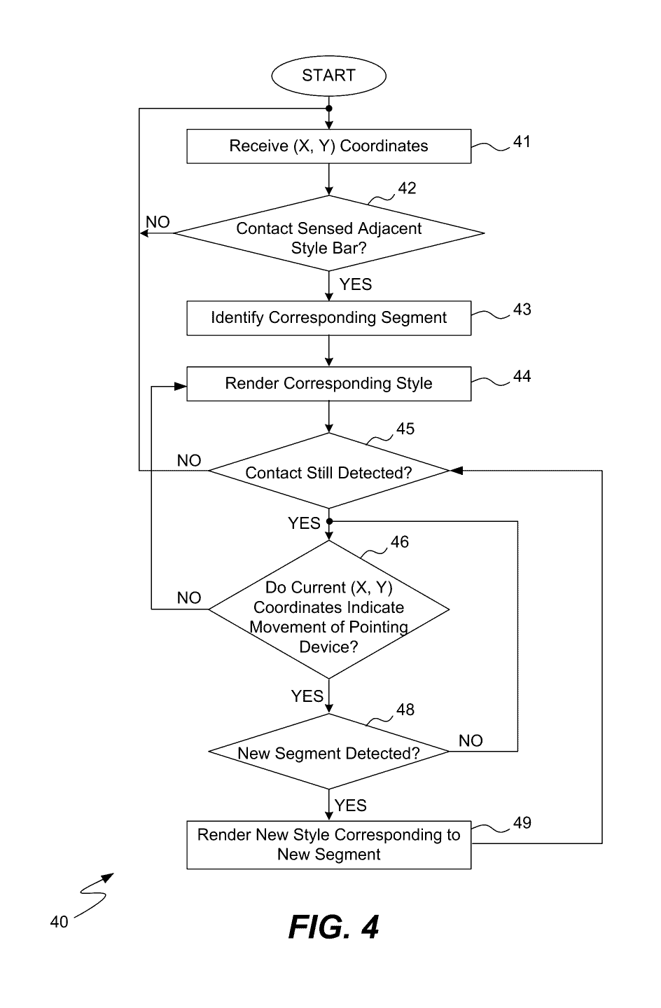

Referring to FIG. 4, a flow diagram illustrating the steps by the authoring tool 20 running on device 16 are illustrated.

In the initial step 41, the sensor circuitry 26 generates the (X, Y) sample coordinates of any contact or motion by a pointing device, such as a finger or stylus, applied to the screen 18.

In decision 42, the event handler 23 of the authoring tool 20 makes a determination if an author is invoking a displayed style selection bar 10.

If yes in step 43, the event handler 23 of the authoring tool 20 ascertains the corresponding segment 12 based on the current (X,Y) coordinate samples.

In step 44, the authoring tool accesses the corresponding style from the related style table 28 once the corresponding segment 12 is ascertained. The component is then rendered in the style accessed from the table. For example, if the style is visual (e.g., a color, font, etc.), the component is rendered on the display 18 with the selected style. If the style is visual (e.g., Digital Signal Processing or DSP filter applied to voice), then the voice with the selected filtering style is rendered (e.g., voice made to sound like Darth Vader, Mickey Mouse, etc.).

In decision 45, it is determined if the pointing device is still in contact with the display 18. If not, control is returned to step 41, awaiting the next contact and the implementation of steps 41 through 45 as described herein.

In decision 46, it is determined by the event handler 23 if the current (X,Y) coordinates generated by the sensor 26 indicate any substantial movement of the pointing device on the display screen 18. If not, the rendering of the same style specified in step 44 is maintained.

In decision 48, it is determined if the movement is sufficient to point to another segment 12 along the style selection bar.

If yes, then a new style corresponding to the newly selected segment 12 read from the style table 28 and is applied to the component.

Thereafter, control is returned to the decision step 45. If contact is still detected, then steps 46 through 48 are repeated, possibly allowing multiple styles to be applied to the component as author moves up and down the style selection bar.

When contact is no longer detected, then the last applied style applied to the component is maintained until the author again contacts the style selection bar.

The above-described flow chart applies for a single style bar. If a particular authoring environment has multiple style bars, then a similar set of operation steps as depicted in FIG. 4 will apply to each.

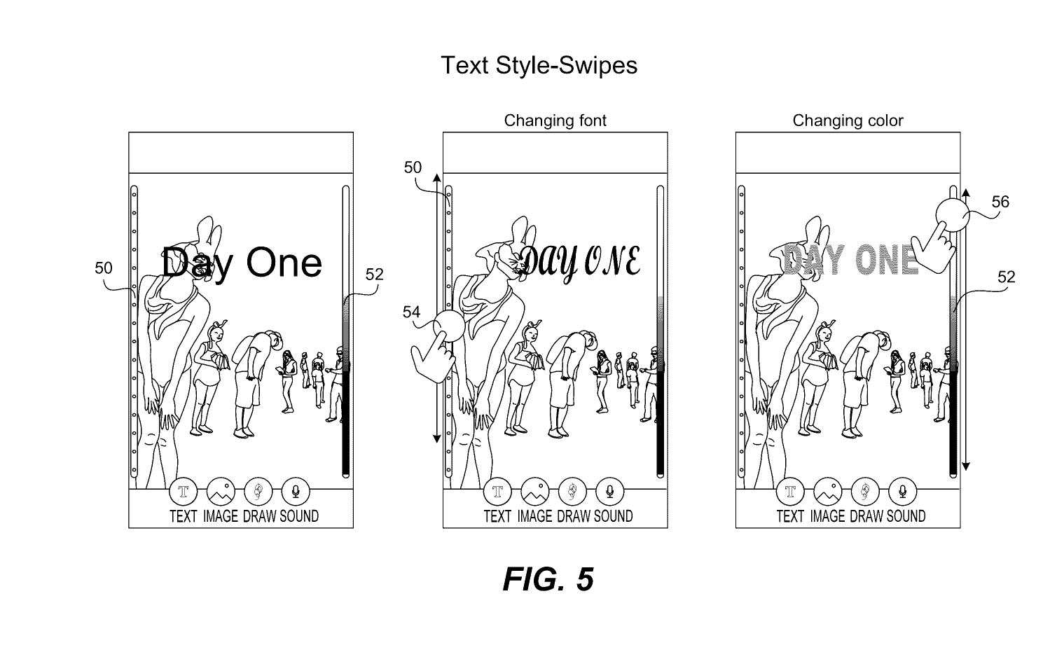

As a tool for authoring documents, the authoring tool 20 enables an author to create various components in a document and then apply one of a plurality of different styles to that component. In various embodiments, the component may be text, an image/photo, drawing/scribble, button, audio and/or video. Once created, an editor (not illustrated) provided within the authoring tool 20, allows the author to stylize the component. In various embodiments, the editor may include multiple style selection bars 10 for the various component types. In the discussion below, various examples of such bars 10 are provided with respect to FIG. 5 through FIG. 9.

FIG. 5 is a diagram illustrating style selector bars for defining styles associated with text components. In this example, as illustrated in the left-most screen shot, a first style selector bar 50 for changing the font and a second style selector bar 52 for changing the color of text is illustrated. As appears in the middle screen shot, an up/down finger swipe, represented by the circle 54, causes the font of “Day One” to change (e.g., from Ariel, Cambria, Calibri, etc.). Similarly, as illustrated in the left most screen-shot, the up/down finger swiping along the second style selector bar 52, as signified by circle 56, causes the color of “Day One” to change (i.e., red, blue, green, yellow etc.). It should be noted that in these examples, just two styles of text are modified using style selector bars 50, 52. It should be understood that any style associated with text, not just those listed herein, could be stylized using style selector bars.

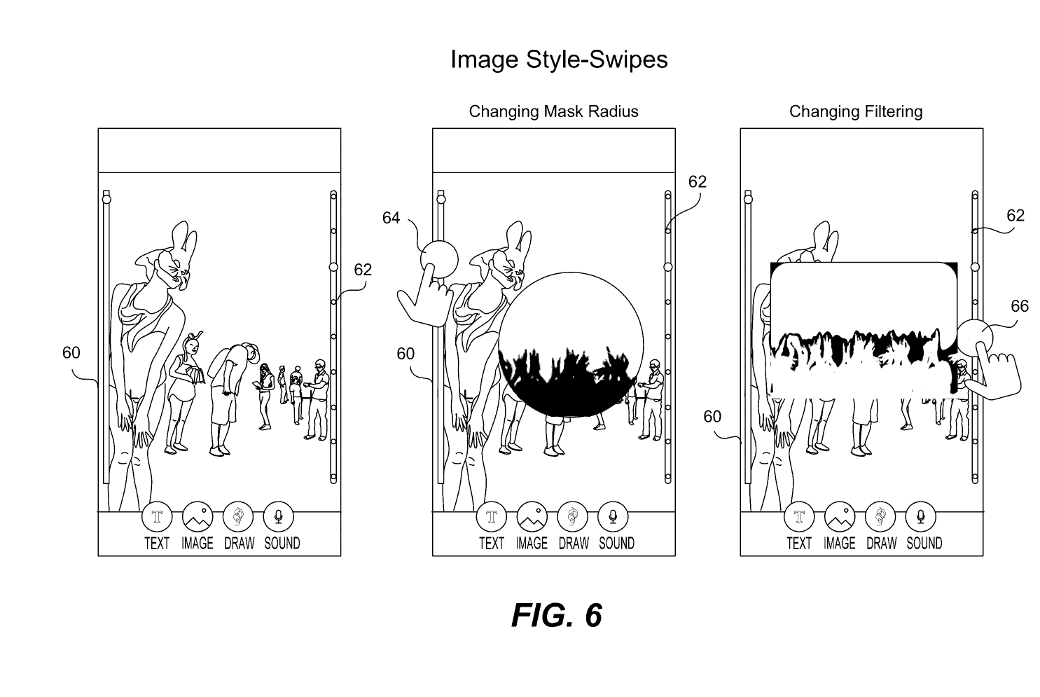

FIG. 6 is a diagram illustrating style selector bars for defining styles associated with image components. As illustrated in the left screen shot, two style selector bars 60 and 62 are shown. The style selector bar 60 is used to adjust a mask radius surrounding an image, while the style selector bar 62 is used adjust the filtering applied to the image. As illustrated in the center screen shot, the radius of the mask surrounding the image can be made larger or smaller in response to the author moving a finger, represented by circle 64, up/down the style selector bar 30. As illustrated in the right screen shot, an up/down finger swipe, represented by the circle 66 along the style selector bar 62 causes the filtering (e.g., black, white, colorized, sepia, etc.) of the image to change. It should be noted that in the above examples, two possible image styles are modified using style selector bars. It should be understood that any style associated with images, not just those listed herein, could be stylized using style selector bars.

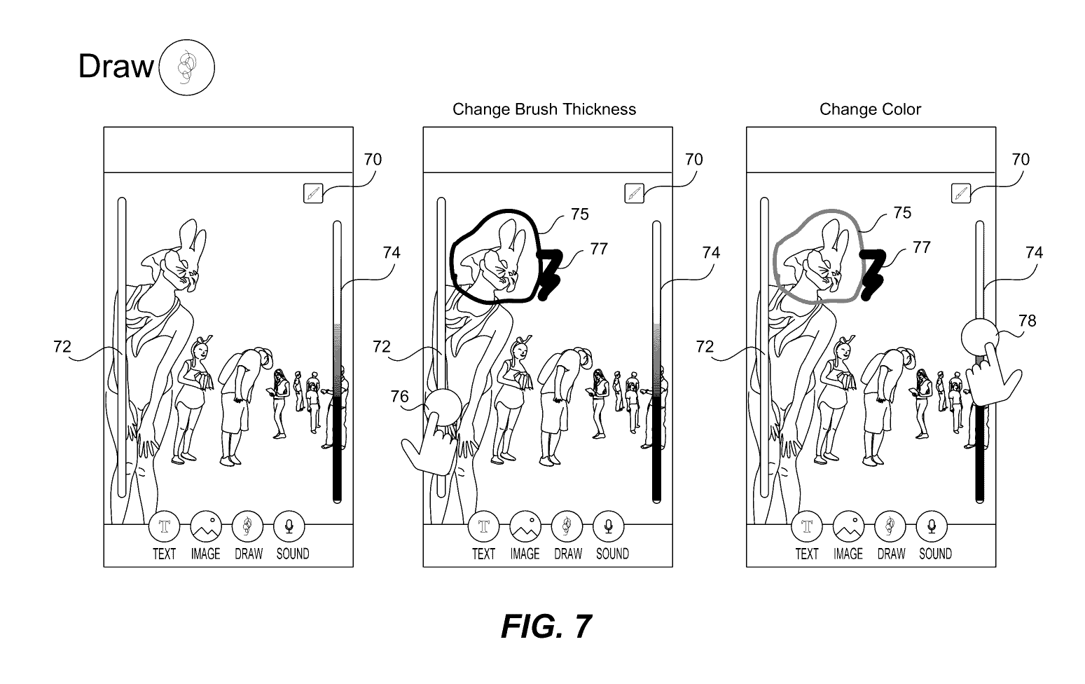

FIG. 7 is a diagram illustrating style selector bars for defining styles associated with drawing/scribble components created by a paintbrush tool 70. As illustrated on the right screen shot, a first style selector bar 72 is used to change brush size or thickness, while the second style selector bar 74 is use to change the color of brush strokes. As illustrated in the middle screen shot, a first stroke 75 of a drawing is created using a first brush thickness. Then, by moving a finger up/down the style selector bar 72, as represented by the circle 76, another brush size or thickness can be defined for the next stroke 77, which is thicker than the first stroke 75 in this instance. As illustrated in the right screen shot, a first stroke 75 of a drawing can be made in a first color (e.g., red) using the paintbrush tool 40. Then, by swiping the style selector bar 74, as represented by the circle 78, a second color for the next stroke 77 can be defined (e.g., black). By repeating the above processes, a drawing with any number of brush stroke sizes, and multiple colors, can be created. Again, any drawing style can be similarly modified using style selector bars.

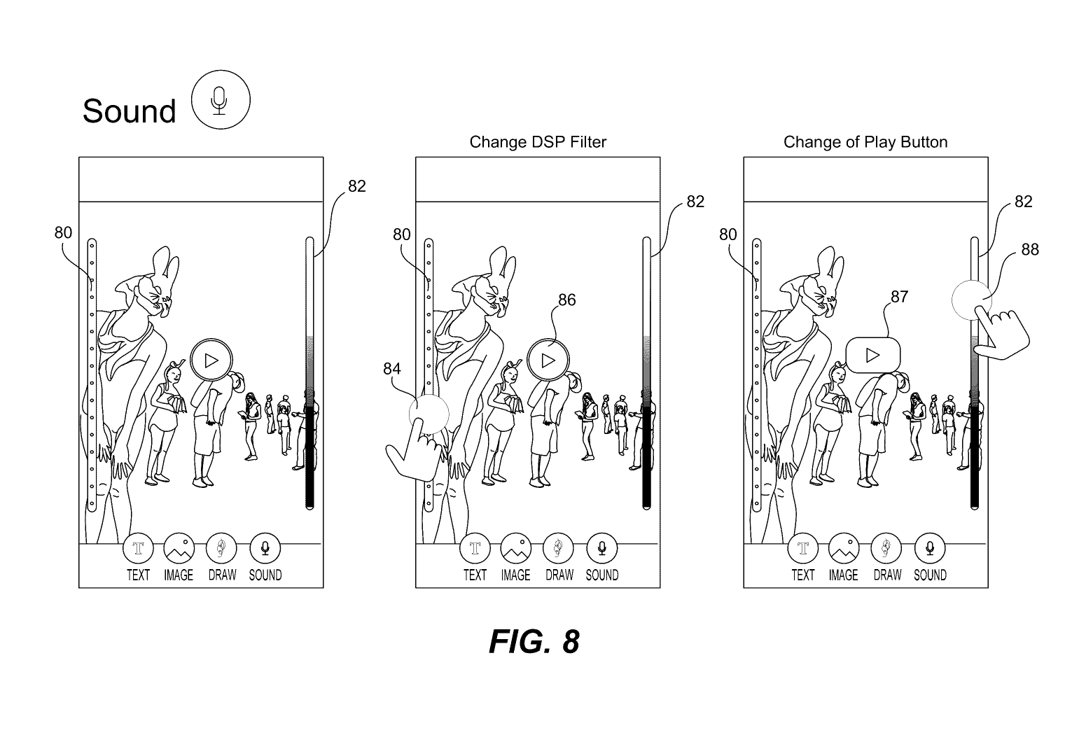

FIG. 8 is a diagram illustrating style selector bars for defining styles associated with sound components. As shown in the left screen shot, two style selector bars 80 and 82 for altering DSP filtering and the color of a play button are provided respectively. As shown in the middle screen shot, swiping the first style selector bar 80, as represented by circle 84, different DSP filters are applied to the recorded audio, for example, to different create sound effects or voice styles. As shown in the right screen shot, swiping along the second style selector bar 82, as represented by the circle 88, the style of the play button 86 can be changed. In this case, the style of the play button is changed from round (element 86 in the middle screen shot) to rectangular (element 87 in the right screen shot). It should be understood that these two style selector bars are merely exemplary. Again, any style associated with sound components could be stylized using style selector bars.

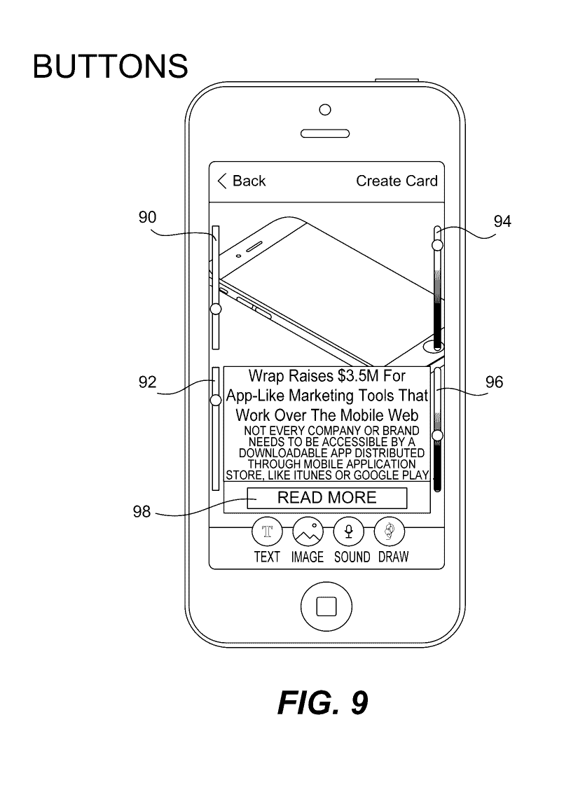

FIG. 9 is a diagram illustrating using four style selector bars for defining styles associated with button components. In this non-exclusive example, the four-style selector bars 90, 92, 94 and 96 are provided to stylize the “READ MORE” button 98. Specifically, the four style selector bars 90, 92, 94 and 96 are provided for stylizing (a) button border radius, (b) button color, (c) font and (d) button color respectively. Again, these style selector bars, and the particular arrangement shown, are merely exemplary. Any style associated with a button could be stylized using similar style selector bars.

The above provides numerous examples of stylizing various constraints associated text, image/photo, drawing/scribble, sound/audio, and button type components. Although no specific examples are provided, style selector bars can similarly be used to stylize constraints associated with video components. For example, style selector bars could be used for stylizing constraints such as mask radius, the graphic representation of the play icon, or applying audio and/or visual filters to the audio and visual media content of the video content.

### Alternative Embodiments

In the embodiments described above, the style selector bar tool is shaped as a straight line or bar. It should be understood, however, that this is by no means a requirement. In alternative embodiments, style selector bars can be configured in any shape, including, but not limited to a curve, round, semi-circular, etc. In addition, all the style selector bar examples provided above are arranged vertically. Again, this is by no means a requirement. Style selector bars can be orientated in any direction, including horizontally, on a diagonal, etc.

In yet other embodiments, style selector bars can be used in mobile or desktop authoring environments. In the case of the former, mobile devices such as mobile or cellular phones or tablets are used. In the case of the latter, desktop computers, workstations and/or laptops may be used. In addition, the pointing device can be either a finger or stylus in the case of touch-sensitive display screens or a mouse controlled curser with non-touch sensitive screens.

While the invention has been particularly shown and described with reference to specific embodiments thereof, it will be understood by those skilled in the art that changes in the form and details of the disclosed embodiments may be made without departing from the spirit or scope of the invention. For example, embodiments of the invention may be employed with a variety of components and should not be restricted to the ones mentioned above. It is therefore intended that the invention be interpreted to include all variations and equivalents that fall within the true spirit and scope of the invention.

What is claimed is:

1. An authoring tool for stylizing components of a document, the authoring tool comprising:
a component tool for defining a component in the document;
a style selector bar tool segmented into a plurality of segments; and
a look up table that associates the plurality of segments with a plurality of stylized choices that can be applied to the component respectively,
wherein the authoring tool is arranged to apply one of the plurality of stylized choices to the component by:
(a) ascertaining a selected segment, among the plurality of segments, of the style selector bar tool;
(b) reading from the look up table the stylizing choice, among the plurality of stylized choices, corresponding to the ascertained selected segment of the style selector bar tool; and
(c) applying the stylized choice read from the look up table to the component.

2. The authoring tool of claim 1, wherein the style selector bar tool is displayed on a display defining an authoring environment for facilitating the authoring of the component into the document and the ascertaining of the selected segment involves interpreting an input applied to the style selector bar tool entered through the display using a pointing device.

3. The authoring tool of claim 1, is further configured to read and apply different style choices among the plurality of style choices included in the lookup table as a pointing device is moved from segment to segment along the style selector bar tool displayed on a display.

4. The authoring tool of claim 1, further comprising an event handler configured to:
(d) receive (X,Y) coordinate information of a location where a pointing device is located on a display screen displaying the style selector bar tool; and
(e) ascertain the selected segment, among the plurality of segments, of the style selector bar tool based on the received (X, Y) coordinate information.

5. The authoring tool of claim 1, wherein:
(d) an event handler is further configured to ascertain when the pointing device is no longer selecting any of the segments of the style selector bar tool; and
(e) the authoring tool is further configured to maintain the application of the stylized choice last read from the look up table to the component after the the pointing device is no longer selecting any of the segments of the style selector bar tool.

6. The authoring tool of claim 1, further comprising categorizing the plurality of stylized choices that can be applied to the component into one of the following groups:
(d) fonts;
(e) colors;
(f) mask radii;
(g) DSP filters;
(h) brush sizes;
(i) brush types;
(j) image/photo filters
(k) mask shapes;
(1) image styles;
(m) text styles;
(n) text justifications/alignments;
(o) button shapes;
(p) button colors;
(q) graphic representations of buttons; or
(r) graphic representations of play icons.

7. The authoring tool of claim 1, wherein the style selector bar tool is bar-shaped.

8. The authoring tool of claim 1, further comprising a plurality of style selector bar tools, each of the plurality of style selector bar tools configured to assign different stylized choices for different constraints of the component respectively.

9. The authoring tool of claim 1, further comprising plurality of style selector bar tools, the plurality of style selector bar tools configured to assign different style choices to a plurality of components of the document respectively.

10. The authoring tool of claim 1, wherein the component is a text component and the plurality of styles that can be applied to the text component are categorized into one of the following categories:
(c) fonts;
(d) colors;
(e) justifications;
(f) alignments;
(g) font styles including one or more of bold, italic, underline, strike-through, highlight, superscript, subscript; or
(h) sizes.

11. The authoring tool of claim 1, wherein the component is an image/photo component and the plurality of styles that can be applied to the image/photo component are categorized into one of the following categories:
(c) color filters;
(d) mask radii;
(e) mask types; or
(f) image styles.

12. The authoring tool of claim 1, wherein the component is a drawing/scribble component and the plurality of styles that can be applied to the drawing/scribble component are categorized into one of the following categories:
(d) brush sizes;
(e) brush types; and
(f) colors.

13. The authoring tool of claim 1, wherein the component is a sound/audio component and the plurality of styles that can be applied to the sound/audio component are categorized into one of the following categories:
(d) sound filters; and
(e) graphic representations of a play button.

14. The authoring tool of claim 1, wherein the component is a button component and the plurality of styles that can be applied to the button component are categorized into one of the following categories:
(d) button shapes;
(e) button border radii;
(f) button colors;
(g) button graphic representations; (h) button label colors; and/or (i) button label fonts.

15. The authoring tool of claim 1, wherein the component is a video component and the plurality of styles that can be applied to the video component are categorized into one of the following categories:
(d) mask radii;
(e) filters; and/or
(f) graphic representations of a play button.

16. The authoring tool of claim 1, further configured to operate in a mobile authoring environment on a mobile device including either a mobile phone or tablet computer and a pointing device used to select the segment, among the plurality of segments, is a finger or stylus.

17. The authoring tool of claim 1, further configured to operate in a desktop authoring environment on a desktop or laptop computer and a pointing device used to select the segment, among the plurality of segments, is one of the following:
(d) a mouse controlled curser; or
(e) a finger or stylus on a touch-sensitive screen associated with the desktop or laptop computer.

18. The authoring tool of claim 1, wherein the style selector bar is one of the following shapes:
(d) a straight line;
(e) circle;
(f) curved;
(g) semi-circular
